(19) United States
(12) Patent Application Publication
(10) Pub. No.: US 2024/0340184 A1
(43) Pub. Date: Oct. 10, 2024

(54) METHOD FOR AUTHENTICATING AN OBJECT AND THE DEVICE AS WELL AS A SYSTEM FOR CARRYING OUT THE METHOD

(71) Applicant: Basler AG, Ahrensburg (DE)

(72) Inventors: Julian Wingert, Pinneberg (DE); Sebastian Adank, Ahrensburg (DE)

(21) Appl. No.: 18/627,238

(22) Filed: Apr. 4, 2024

(30) Foreign Application Priority Data
Apr. 5, 2023 (DE) 102023108677.4

(51) Int. Cl. H04L 9/32; G06K 7/10; G06K 7/14

(52) U.S. Cl. CPC H04L 9/3247; G06K 7/10722; G06K 7/1413; H04L 9/3278

(57) ABSTRACT

A method for authenticating an object comprises receiving image data of an image camera of a device comprising the object, recording a barcode, in particular, a two-dimensional barcode, such as a QR code, in the image data with a third-party public key as well as storing the image data with the barcode. The method also comprises generating a digital signature with the device's own private key depending on the image data as well as providing the image data and the digital signature.

### BACKGROUND

### Technical Field

Embodiments of the invention relate to the field authenticating objects, such as documents, items or people for example. In particular, embodiments of the invention relate to a method for authenticating an object as well as a device and system for carrying out the method. Furthermore, embodiments of the invention relate to a computer-program product which comprises instructions for carrying out the method, preferably on a device.

### Description of the Related Art

Proof that an object comprises certain characteristics or a certain state is referred to as authentication of an object. Objects within the meaning of the present application essentially relate to tangible items and people. In this respect, authentication corresponds to proving a claimed characteristic of an entity, namely an object, wherein the claimed characteristic, for example, is the characteristic that, in the case of the entity, has to do with the original one.

The authentication of objects, for example, refers to the process of checking the authenticity or validity of a certain object to ensure that it is indeed what it claims to be. This can be used, for example, to check documents such as ID cards, certificates, contracts or to authenticate products such as electronic devices, clothing or jewelry.

One objective of object authentication may be to avoid forgery or tampering in order to ensure that the object actually has the characteristics or property rights attributed to it. The authentication of objects is used in many areas, such as the art trade, banking, food or drug safety, and the IT security of products.

Object authentication can be carried out in a variety of ways depending on the type of object and available technologies. Some examples of methods of authenticating objects include the use of serial numbers, watermarks, holograms, or special markings printed or imprinted on the object. However, such methods are often not forgery-proof and are not applicable to every type of object.

Authentication is particularly well-known in the area of data exchange or when accessing data that is stored in a secure area. A user, via his/her username, indicates the claim that they correspond to a specific person. By providing an additional password, he/she can authenticate his/her person. The user is authenticated when the password matches the username and thus the user has authenticated his/her claim that he/she is a specific user via the password. If the user is then authenticated to the system, he or she can, for example, access the backed-up data.

Such a method, known from the field of data exchange, is not applicable for the authentication of objects since objects, particularly if the objects are items, cannot contribute to authentication on their own. Therefore, authentication is usually carried out by a person. In legal transactions, for example, notaries are known to certify or verify the authenticity or originality of a document.

Accordingly, methods for authenticating objects, such as people and documents for example, have only been possible under certain conditions by certain people up until this point However, it is desirable to authenticate objects in a standardized and simple way in everyday life, particularly in a private or business environment.

If, for example, a service is provided in the form of a repair or installation or if damage occurs, for example, as a result of a traffic accident, it is desirable to authenticate the manufactured condition of the object in order to reliably document verifiability of the condition for later evaluation, for example, for the evaluation of complaints.

Accordingly, some embodiments counter the problems of prior art. In particular, a possibility for authenticating an object should be created that can be executed with reasonable effort in a standardized form, preferably by any person. In any case, an alternative to what is known from prior art is to be found.

### BRIEF SUMMARY

An embodiment relates to a method of authenticating an object, wherein the object is, for example, an item, such as a document, or also a tangible good, such as a machine or a device. An object can also be a living being, such as a person, an animal, or a plant for example. The method concerns the authentication of the object, in particular the confirmation of a characteristic of the object, such as a state thereof for example.

In accordance with the method, image data of an image comprising the object is first received by a camera of a device. Preferably, a picture of the object is taken with a camera of the device. The image data of the object is received, for example, directly from the image sensor or from a buffer memory in which the image data was temporarily stored after being captured. The image data can also be received via a data interface of the device.

The image data is received preferably after the image has been taken with a camera. For example, taking the image with the camera can be done by a user manually, or it can be triggered automatically as soon as a barcode is detected. Furthermore, it can also be triggered by another application or by receiving a signal.

In addition, a barcode is captured in the image data. For example, the barcode is a one-dimensional barcode, such as a barcode made up of lines, or a two-dimensional barcode, such as a QR code. The barcode also contains a third-party public key. The third-party public key is preferably a public key of a key pair used for asymmetric encryption. The third-party public key corresponds to a public key that is not the public key of the device receiving the image data.

Capturing the barcode preferably comprises detecting whether a barcode is contained in the image data and whether the third-party public key is contained in the barcode. Preferably, the data of the barcode is extracted by the device. Furthermore, it is preferable to abort the method if no third-party public key is recognized and to continue only if the detection is successful.

The method also includes storing the image data with the barcode, preferably in the device. For example, the image data with the barcode can be stored depending on the barcode being captured. In particular, it is therefore possible not to process and/or save the data in the event that no barcode is recorded. In particular, in the event that a barcode is recognized, the further steps described herein are carried out. Accordingly, storing the image data with the barcode is also preferably only carried out if a barcode has previously been captured.

It is preferable not to check the correctness of the third-party public key contained in the barcode. However, it can also be provided in accordance with a further embodiment to match the third-party public key with a database, for example, to check whether the third-party public key exists and/or is assigned to a person. In the case of a non-existent third-party public key, in the latter case for example, the method could be aborted and storing of the image data could only take place if the third-party public key can be extracted from a database, such as a certificate authority for example. Storing the image data also involves caching or buffering the image data.

Furthermore, a digital signature is generated with the device's own private key depending on the image data. This means that the image data is signed, for example, with one's own private key. Your own private key is preferably a private key of a key pair used for asymmetric encryption. Accordingly, the key pair also comprises a device's own public key. Your own private key corresponds to a private key of the device. Preferably, it is possible not to sign the complete image data with your own private key but to first form a hash with a predefined hash function from the image data and sign this hash.

In addition, the image data and the digital signature are provided in a further step.

The object is thus authenticated with the digital signature by the device based on the image data. By encrypting with the device's own private key, the device that received the image data generates a piece of information, namely the signature, that the device recognizes the received image data as trustworthy. The characteristics of an object recognizable on the image of the image data are thus confirmed.

For example, the method can be used to document any everyday situation. One use case may be to document damage to a vehicle after a traffic accident. For example, an injured person can position a barcode with the injured person's public key, which corresponds to the third-party public key, represented by, for example, a mobile phone, in the area of an accidental damage of a vehicle. The device is then used to take a picture, for example of the person who caused the accident, on which the damage and the barcode with the third-party public key can be recognized. In the device, the digital signature is then generated with the device's own private key depending on the image data. The image data as well as the digital signature can then be made available to the injured person, for example by sending it. With the signature, the person who caused the accident confirms the condition of the damage for the injured party.

In this way, a method is created with which the characteristics of objects in everyday use can be documented and verified in a manageable way. Authentication can thus be made possible by devices configured for the method at any location without the need for certification by a single person, such as an expert or witness for example. Other use cases include the documentation of repair or installation of objects, the acknowledgement of documents, the originality of documents or works of art or the like.

In accordance with a first embodiment, the image data is integrated into an image file and the digital signature into additional data of the image file. An example of such additional data is metadata of the image file. Providing the image data and digital signature then corresponds to providing the image file.

Providing the imagery and digital signature in the form of a single file is beneficial for making that single file available either to the public or to another person in a standardized form. In particular, the image file can be transmitted as a single file in familiar ways. Preferably, the image file can be transmitted to the other device that provides the third-party public key in the form of the barcode.

For the above-mentioned example of the traffic accident, image files with the corresponding signatures of the two parties involved in the accident can thus be exchanged among the parties involved in the accident, wherein the signatures each correspond to one of the parties agreeing to the other party that the recorded damage occurred.

This makes it easy to exchange the signed image data.

In accordance with another embodiment, the barcode contains additional information in addition to the third-party public key. In addition to the third-party public key, other data can be extracted from the barcode, which is referred to as additional information. The additional information comprises data that, in accordance with a specific embodiment, indicates a current time or date, preferably the time or date on which the barcode is displayed.

In accordance with another further embodiment, the data of the barcode indicates information about the device that displays the barcode. Such information about the device may be, in particular, information about a camera, such as a serial number or designation of the device.

In accordance with another further embodiment, the data gives information about a user of the device. Such information about a user of the device may be, for example, a user's name or similar other identifiers of the user. In this case, the user preferably corresponds to the person to whom the asymmetric key pair of the device displaying the barcode is assigned.

In accordance with the embodiment or one or a plurality of the further embodiments, the additional information is extracted from the image data with the device. Accordingly, the device is set up to extract not only the third-party public key but also other information, namely the additional information, from the barcode of the image data. This additional information can also be stored as plain text, metadata or in any other way in order to authenticate not only the content of the image, i.e., the object, with a specific state, but also to indicate the people involved in the authentication, a device used for authentication, or a time when the characteristics of the object to be authenticated existed.

In accordance with another embodiment, the digital signature is generated depending on the additional information extracted. The digital signature is therefore generated depending on the image data as well as the additional information. For example, the signature not only confirms the image data with the object, but also the additional information, such as when the image was taken.

Accordingly, not only the characteristics of the object that can be displayed in the image can be authenticated with the method. In addition, it is also possible to clearly determine, for example, at what point in time the object was authenticated and/or who was involved in this authentication by signing the additional data.

In accordance with another embodiment, the digital signature corresponds to an image signature. The image signature corresponds to an encryption of the received image data with the user's own private key. Accordingly, only the image data of the image containing the object and the third-party public key are signed. For example, a hash is generated from the image data and this hash is encrypted with the private key, i.e., signed. Since the image data contains the barcode with further information, the authenticity of the barcode data can also be inferred by determining the authenticity of the image data with the signature. The other information, such as the third-party public key and/or the additional information, can also be extracted from the image data at a time after signing. A signature can therefore be executed with the device with low complexity.

In accordance with another embodiment, the digital signature comprises an image signature and a key signature. The image signature is generated by encrypting the received image data with the device's own private key. Accordingly, as with the aforementioned embodiment, for example, a hash of the image data is formed, and this hash is encrypted with the user's own private key in order to generate the image signature. Furthermore, the third-party public key and preferably also the additional information specified in the barcode of the image file are also encrypted with the user's own private key in order to generate a key signature. Accordingly, the third-party public key is extracted from the image data beforehand.

Both signatures, namely the image signature and the key signature, can thus be verified separately by a recipient who receives the provided image data and the digital signature. Preferably, the recipient does not also have to extract the public key from the image data.

In accordance with another embodiment, the signature corresponds to a combination signature. The combination signature is characterized in that the image data, the third-party public key contained in the barcode of the image data, and preferably also additional information contained in the barcode, are first combined with each other and then the combined data is encrypted, i.e., signed, with the user's own private key.

A combination of the image data with the third-party public key and preferably the additional information can be matched, for example, by simply arranging the corresponding data sequentially and forming an overall hash over all data. This further increases the security of the signature.

In accordance with another embodiment, the method involves displaying the device's own barcode with the device's own public key in a display of the device. Accordingly, the device is also designed to provide its own public key itself as a barcode in order to carry out the steps described above for authenticating an object with another or further device, which can also be referred to as a third-party device. In particular, the barcode is provided after the image data with the object and the digital signature has been provided. This makes it possible to photograph and sign the image data with two devices. Preferably, your own barcode also includes additional information. This additional information corresponds to the additional information referred to above, in particular, a current time or date on which the barcode is displayed, information about the device or information about a user of the device.

In accordance with another embodiment, two devices that correspond, for example, to mobile devices, such as a mobile phone or a tablet for example, and comprise a front-facing camera, can simultaneously display a barcode and record the barcode of the other device and other image content, such as the faces of the respective users for example. For this purpose, the method in accordance with an embodiment relates to the fact that, after the barcode has been displayed by one device, a synchronization signal from another device is waited for. After receiving the synchronization signal, the received image data is stored in order to sign them.

The synchronization signal preferably indicates that the other device has detected its own barcode. Preferably, the device, which can also be referred to as a person's own device, also sends another synchronization signal to the other device as soon as its own device has captured the barcode of the other device or stored the image data received. In the example mentioned above, for example, in which the mobile devices with their front cameras have captured each other's barcodes, the synchronization signal and preferably the further synchronization signal can then generate image data at the same points in time that signing can occur. For example, two people, one of whom is holding their own device, and the other person is holding another device next to their face, can verify each other for example. Corresponding points in time in additional information of the respective barcodes can confirm the synchronization or simultaneous recording of the image data.

In accordance with another embodiment, the method includes the receipt of third-party image data and a third-party digital signature, in particular as a file, which is referred to here as a third-party image file. For example, a third-party image file corresponds to an image file that contains image data taken by another device, i.e., a third-party device that does not correspond to a person's own device. The image file corresponding to the third-party image file also includes a digital signature, which also originates from the other device and is preferably included in the metadata of the third-party image file.

In addition, it is checked whether the received third-party image data contains an image with a barcode. Furthermore, it is also checked whether the barcode contains your own public key. In addition, the third-party image data and the third-party digital signature, particularly in the event that the previous checks were successful, i.e., the third-party image data comprise a barcode, and the barcode includes the user's own public key, are stored in a database that corresponds, for example, to a memory.

It is therefore possible to authenticate an object by, for example, returning to the above example of a traffic accident, the victim of the accident provides his or her own public key as a barcode next to the damage with his or her device, which corresponds to a mobile phone, for example. The injured party then asks the person who caused the accident to take a photo of the accident damage as well as their own public key with a third-party device, such as the mobile phone of the person who caused the accident for example, as proof. The person who caused the accident then signs the image file and makes it available to the injured party. The injured party receives the third-party image data and the third-party digital signature and saves them after the aforementioned check. The person who caused the accident thus confirms the accident damage for the accident victim by means of the signature. In a similar way, a technician can have his/her installation performance documented by another person with a third-party device.

In accordance with another embodiment, the database in which the third-party image data and the third-party digital signature are stored is a publicly accessible database to which unrestricted data access is possible. Alternatively, the database is a protected database to which authorized users have access. To take up the example of the traffic accident again, the example is supplemented in accordance with the latter embodiment. Accordingly, it may be envisaged that the database, as a database, corresponds to an insurance policy that is likely to settle the accident damage. Accordingly, the database corresponds to a database of the insurance company, to which the policyholder can directly upload the image data and the signature. Both parties involved in the accident can load image data and signatures into each other's database in order to provide each other's public keys simultaneously.

In accordance with another embodiment, the database is stored on a remote computer, as mentioned earlier in the example. Alternatively, the database is a local database, namely in a memory of the device or the other device. Thus, if the database is a database that resides locally on the device, corresponding image data and signatures can be retrieved at any point in time, i.e., on demand.

In accordance with another embodiment, the database includes an identifier to assess the trustworthiness of the image data and the digital signature. The identifier is preferably generated depending on the image data and digital signature provided in the database. The identifier is therefore used to give other people who take the image data and the digital signature from a database an additional indication of how reliable the authentication is. This can be done, for example, depending on a set of image data and digital signatures that can be assigned to a specific person. For example, the more authentications a person has carried out, the more trustworthy that person can be evaluated for example. In particular, such assessments of trustworthiness can also be made on the basis of the standards set out in a so-called “Web of Trust.” For example, depending on the status of the user of the database, identifiers can be provided to the user for the trustworthiness of the user and thus for the trustworthiness of the image data and signatures.

In accordance with another embodiment, one's own private key is generated or generated depending on a physically unclonable function, which is also called a “physical unclonable function,” or PUF for short. The device used to capture an image generates its own private key to sign an image file, wherein its own private key is generated depending on a physical characteristic of one or a plurality of components of the device that captured the image.

The security of one's own private key is increased by using a PUF, since one's own private key does not have to be stored in the device, or at least not permanently, but can be generated from the PUF at any time when it is needed.

Furthermore, an embodiment relates to a computer-program product. The computer-program product includes instructions which, when carried out on a device, cause the device to carry out the method according to one of the preceding embodiments. The device is preferably a mobile device, such as a mobile phone, tablet or portable computer for example.

In addition, an embodiment relates to a device for authenticating an object. The device includes a memory and a processor. The device is designed to carry out the method according to one of the above embodiments. Preferably, the device is set up by a computer program as described herein to authenticate an object. The device is preferably a mobile device, namely in particular, a mobile phone, a portable computer or a tablet computer. In addition, the device has a camera for capturing images to provide image data and a wireless interface.

In addition, an embodiment relates to a system with a plurality of devices as described herein. The plurality of devices comprise at least two devices, wherein one device is one's own device and a second device is the other device or third-party device.

In accordance with an embodiment of the system, the system also includes a database in a remote computer's memory. The remote computer, and preferably each of the devices, is set up to communicate with the database via a wireless interface of the device in question.

### BRIEF DESCRIPTION OF THE SEVERAL VIEWS OF THE DRAWINGS

Further embodiments emerge from the embodiments explained in more detail in the figures.

FIG. 1 shows a system in accordance with an embodiment with a device in accordance with an embodiment and another device.

FIG. 2 shows the steps of a method in accordance with an embodiment.

FIG. 3 shows the steps of the method in accordance with another embodiment.

### DETAILED DESCRIPTION

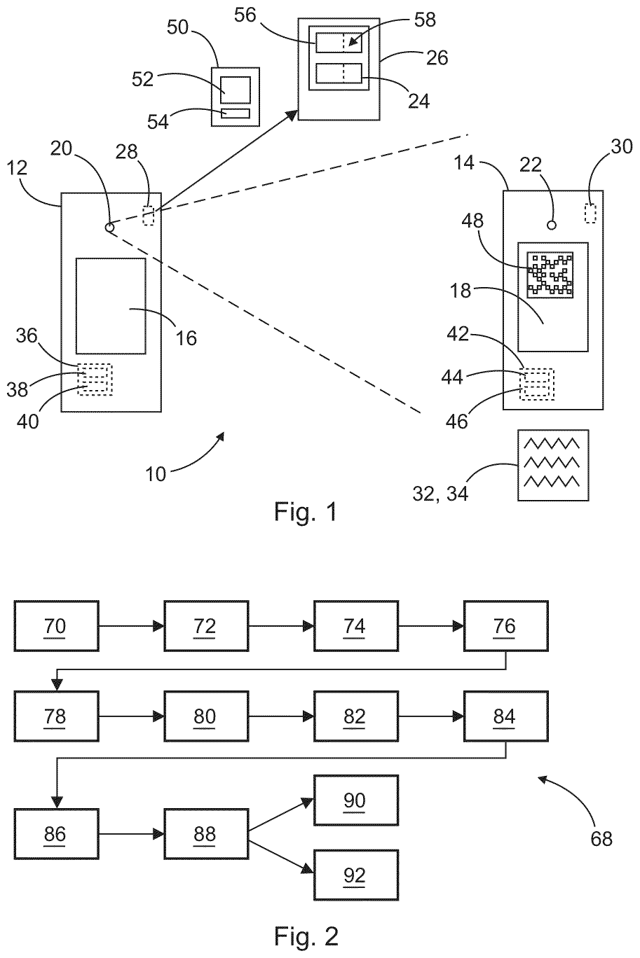

FIG. 1 shows a system 10 in accordance with an embodiment, which comprises a plurality of devices 12, 14, wherein each of the devices 12, 14 is set up to carry out the method in accordance with an embodiment.

Device 12 and Device 14 each comprise a display 16, 18 and a camera 20, 22. In addition, a database 24 is represented in a remote computer 26. Devices 12 and 14 also each have a wireless interface 28 and 30 in order to exchange data wirelessly, i.e., wirelessly, with the remote computer 26. The wireless interfaces 28, 30 can also be used to exchange data between devices 12, 14. In addition, an object 32 is depicted, which corresponds to a document 34.

The device 12, which is referred to here as a separate device, also comprises a memory 36. The device 12 saves its own private key 38 and its own public key 40 in memory 36. If the other device 14 is described as another device or a third-party device, then a private key and a public key are also stored in a memory 42, which is also contained in the other device 14, which are referred to here as someone else's private key 44 and someone else's public key 46. The displays 16, 18 are set up to represent a barcode 48.

In FIG. 1, the object 32 is first authenticated by the person's own device 12. For this purpose, a barcode 48 is displayed with the display 18 of the other device 14. Device 12 uses camera 20 to take a photograph showing the object 32 and a barcode 48. Device 12 then generates a digital signature with its own private key 38 depending on the image data generated by camera 20. An image file 50, which contains image data 52 and the call number 54, is then transmitted to the database 24 and stored in the database 24 as an entry 56. The entry 56 is assigned an identifier 58, which indicates the trustworthiness of the entry 56.

In order to increase the trustworthiness of the authentication of the object by means of the image file 50, the positions of the devices 12, 14 can be swapped in a step not shown in FIG. 1. The other device 14 then takes a representation of device 12, which displays a barcode containing the public key 40 of device 12 and the object 32.

Alternatively, instead of the object 32, which in this case corresponds to document 34, a mutual authentication of second people can also be carried out, each holding devices 12, 14, for example next to their faces, and taking a photo of the other device 12, 14 and of the face of the person assigned to the device accordingly with the device 12, 14. The signed image data of devices 12, 14 are then transmitted to the database 24, for example.

FIG. 2 illustrates the steps of a method 68 in accordance with an embodiment. At step 70, a barcode 48 is displayed with a device 14, which can be described as a third-party device. At step 72, a trigger signal is received by a device 12, which can also be referred to as its own device. At step 74, an image is taken showing the barcode 48 displayed with the third-party device 14. An image sensor that captured the image receives image data 52 at step 76 and the barcode 48 in image data 52 at step 78. At step 80, a third-party public key 46 is recognized in the barcode 48 and additional information is entered at step 82. Step 84 is where the collected data is stored. Storing preferably corresponds to caching for further processing of the image data 52. At step 86, a signature 54 is created with your own private key 38. Step 88 provides image data 52 and digital signature 54. At step 90, image data 52 and digital signature 54 are stored in a database 24. Preferably, or alternatively, the provided image data 52 and the digital signature 54 are transmitted to the third-party device 14 in a step 92.

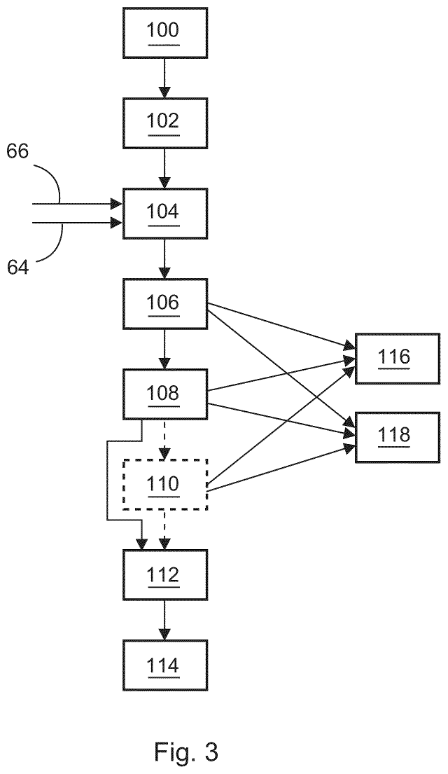

FIG. 3 shows further steps in accordance with another embodiment of the method. At step 100, a barcode 48 is provided with device 12, which is called an own device. It then waits for the receipt of third-party image data at step 102. After receiving the third-party image data 66 and a third-party digital signature 64 at step 104, a check is carried out at step 106 whether a barcode is contained in the image data and at step 108 whether this barcode corresponds to the user's own public key. In an optional step 110, it is checked whether the third-party digital signature 64 is valid for a third-party public key 46 of the third-party device 14. If this step is completed successfully, if it exists, or even without this step, if it is not provided, the third-party image data 66 at step 112 and the third-party digital signature 64 at step 112 are stored on it. At step 114, the third-party image data 66 and the third-party digital signature 64 are optionally transmitted to a remote database 24. If one of the checks 106, 108, 110 fails, the data is deleted at step 116, or a message is output to a user at step 118 that authentication has failed.

### REFERENCE LIST

10 system
12 own device
14 other device/third-party device
16 display of own device
18 display of the additional device/third-party device
20 camera belonging to own device
22 camera of the other device/third-party device
24 database
26 remote computer
28 wireless interface of own device
30 wireless interface of further device/third-party device
32 object
34 document
36 memory
38 own private key of own device
40 own public key of own device
42 storing of the other device/third-party device
44 third-party private key of other device/third-party device
46 third-party public key of further device/third-party device
48 barcode
50 image file
52 image data
54 signature
56 entry
58 identifier
64 third-party digital signature
66 third-party image data
68 method
70 showing barcode
72 receiving a trigger signal
74 capturing an image
76 receiving image data from image sensor
78 capturing barcode in image data
80 detecting third-party public keys in barcodes
82 capturing additional information
84 storing captured data
86 generating signature with your own private key
88 providing image data and digital signature
90 storing image data and digital signature in a database
92 transfer of image data and digital signature to the third-party device
100 providing a QR code
102 waiting for third-party image data to be received
104 receiving third-party image data
106 checking if a barcode is included in image data
108 checking if barcode matches your public key
110 checking that a signature with a third-party public key is valid
112 storing image data and digital signature
114 transferring image data and digital signature to remote database
116 delete data
118 issuing a message concerning failed authentication

German patent application no. 10 2023 108677.4, filed Apr. 5, 2023, to which this application claims priority, is hereby incorporated herein by reference, in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for authenticating an object, comprising:
receiving image data of an image comprising the object from a camera of a device,
capturing a barcode in the image data with a third-party public key,
storing the image data with the barcode,
generating a digital signature with the device's own private key depending on the image data, and
providing image data and digital signature.

2. The method according to claim 1, wherein the image data are integrated into an image file and the digital signature is integrated into additional data, in particular metadata, of the image file and the provision of the image data and the digital signature corresponds to the provision of the image file.

3. The method according to claim 1, wherein the captured barcode comprises additional information, wherein the additional information comprises:
data indicating a current time and/or date, preferably at or on which the barcode is displayed, and/or
data indicating information about the device displaying the barcode, in particular information about a camera of the device, and/or
data indicating information about a user of the device,
wherein the additional information is extracted from the image data with the device.

4. The method according to claim 3, wherein the digital signature is generated as a function of the extracted additional information.

5. The method according to claim 1, wherein:
a) the digital signature corresponds to an image signature generated by encrypting the received image data with the device's own private key, or
b) the digital signature comprises an image signature and a key signature, wherein the image signature is generated by encrypting the received image data with the device's own private key and the key signature by encrypting the third-party public key with the device's own private key, or
c) the signature corresponds to a combination signature generated by encrypting the combined image data received and the third-party public key, and preferably the additional information, with the device's own private key.

6. The method according to claim 1, wherein the method comprises the display of the device's own barcode with the device's own public key in a display of the device, in particular, after providing the image data with the object and the digital signature, wherein the device's own barcode preferably also comprises additional information.

7. The method according to claim 6, wherein the device waits for a synchronization signal from another device after displaying the barcode and stores the received image data after receiving the synchronization signal, wherein the synchronization signal indicates that the further device has detected its own barcode, wherein preferably the device sends a further synchronization signal to the further device as soon as the device has captured the barcode and/or has stored the received image data.

8. The method according to claim 1, wherein the method comprises the receipt of third-party image data and a third-party digital signature, in particular as a third-party image file, further comprising:
checking whether the received third-party image data contains an image with a barcode,
checking whether the barcode comprises the device's own public key and
storing the third-party image data and the third-party digital signature, in particular, the third-party image file, in a database.

9. The method according to claim 8, wherein the database is a publicly accessible database to which unrestricted data access is possible, or the database is a protected database to which authorized users have access, wherein the database is stored locally on the device or in a memory of a remote computer.

10. The method according to claim 8, wherein the database provides an identifier for assessing the trustworthiness of the image data and the digital signature, wherein the identifier is generated preferably depending on image data and digital signatures provided in the database.

11. The method according to claim 1, wherein at least the device's own private key is generated depending on a PUF of the device.

12. A computer-program product comprising instructions which, when executed on a device, in particular, a mobile device, cause the device to carry out the method according to claim 1.

13. A device for authenticating an object, comprising a memory and a processor, wherein the device is configured, in particular, by a computer-program product according to claim 12, wherein, preferably, the device is a mobile device, in particular, a mobile phone, a portable computer or a tablet computer, and also comprises a camera for recording image data and a wireless interface.

14. A system comprising a plurality of devices according to claim 13.

15. The system according to claim 14, furthermore comprising a database in a memory of a remote computer, wherein the remote computer and each of the devices are set up to communicate with each other via a wireless interface of the device.

16. The method according to claim 1, wherein capturing the barcode includes capturing a two-dimensional barcode.

17. The method according to claim 1, wherein capturing the barcode includes capturing a QR code.
